(19) United States
(12) Patent Application Publication
(10) Pub. No.: US 2009/0040209 A1
(43) Pub. Date: Feb. 12, 2009

(54) PLASMA DISPLAY AND DRIVING METHOD THEREOF

(76) Inventor: Jae-Seok Jeong, Suwon-si (KR)

Correspondence Address: CHRISTIE, PARKER & HALE, LLP, PO BOX 7068, PASADENA, CA, 91109-7068, US

(21) Appl. No.: 12/179,365

(22) Filed: Jul. 24, 2008

(30) Foreign Application Priority Data
Aug. 7, 2007 (KR) 10-2007-0079030

(51) Int. Cl. G09G 5/00; G09G 3/28

(52) U.S. Cl. 345/212; 345/211; 345/60

(57) ABSTRACT

In a driver for driving an address electrode in a plasma display, a power recovery switch is coupled between a power recovery capacitor and the address electrode, and a driving switch is coupled between a power source for supplying an address voltage and the address electrode. A grounding switch is coupled between a ground terminal and the address electrode. The power recovery switch, the driving switch, and the grounding switch are formed in one integrated circuit. The address electrode driver turns on the power recovery switch during a first period within a period for varying a voltage at the address electrode from a 0V voltage to a Va voltage and turns on the power recovery switch during a second period within a period for varying the voltage at the address electrode from the Va voltage to the 0V voltage. The power recovery switch is turned on for about 62 ns.

### CROSS-REFERENCE TO RELATED APPLICATION

This application claims priority to and the benefit of Korean Patent Application No. 10-2007-0079030 filed in the Korean Intellectual Property Office on Aug. 7, 2007, the entire content of which is incorporated herein by reference.

### BACKGROUND OF THE INVENTION

(a) Field of the Invention

The present invention relates to a plasma display device and a driving method thereof.

(b) Description of the Related Art

A plasma display panel (PDP) is a flat panel display that uses plasma generated by gas discharge to display characters or images. It includes, depending on its size, several hundreds of thousands to millions of discharge cells (hereinafter referred to as “cells”) arranged in a matrix pattern.

In general, one frame of the plasma display is divided into a plurality of subfields to drive the plasma display. A scan pulse is sequentially applied to a plurality of scan electrodes and address pulses are selectively applied to a plurality of address electrodes in synchronization with the scan pulse in an address period of each subfield. Here, since the scan and address electrodes operate as a capacitor, a capacitance is formed in the panel. Accordingly, in addition to power for generating an address discharge, reactive power for generating a predetermined voltage at a panel capacitor is required to apply an address pulse to the address electrodes. Therefore, to recover and reuse reactive power generated when address pulses are applied to the address electrodes, a capacitor for power recovery is used to charge or discharge the panel capacitor. Here, if the time it takes to charge or discharge the panel capacitor is short, the power recovery efficiency is reduced, and if the time it takes to charge or discharge the panel capacitor is long, the pulse width is reduced, resulting in an erroneous address discharge.

The above information disclosed in this Background section is only for enhancement of understanding of the background of the invention and therefore it may contain information that does not form the prior art that is already known in this country to a person of ordinary skill in the art.

### SUMMARY OF THE INVENTION

Exemplary embodiments according to the present invention provide a plasma display for improving power recovery efficiency while reducing a failure rate of address discharge and a driving method thereof.

A plasma display according to an exemplary embodiment of the present invention includes a plasma display panel including an electrode, and a driver. The driver includes a power recovery capacitor and a driving circuit. The driving circuit includes a switch for controlling a current path between the power recovery capacitor and the electrode. The switch is turned on during a first period within a period for varying a voltage at the electrode from a first voltage to a second voltage, and is turned on during a second period within a period for varying the voltage at the electrode from the second voltage to the first voltage. Each of the first and second periods is greater than about 62 ns.

According to another exemplary embodiment of the present invention, a method for driving a plasma display including a plasma display panel, an address driver, and a power recovery capacitor is provided. The plasma display panel includes an address electrode, and the address driver includes a switch coupled to the address electrode for controlling a current path between the address electrode and the power recovery capacitor. According to the method, a voltage at the address electrode is varied from a first voltage to a second voltage, the switch is turned on during a period for varying the voltage at the address electrode from the first voltage to the second voltage, the voltage at the address electrode is varied from the second voltage to the first voltage, and the switch is turned on during a period for varying the voltage at the address electrode from the second voltage to the first voltage. The switch is turned on for about 62 ns.

### BRIEF DESCRIPTION OF THE DRAWINGS

FIG. 1 is a block diagram of a plasma display device according to an exemplary embodiment of the present invention.

FIG. 2 is a simplified circuit diagram of the address electrode driver of FIG. 1 according to the exemplary embodiment of the present invention.

FIG. 3 is a waveform diagram representing signal timing of the address electrode driver shown in FIG. 2.

FIGS. 4A, 4B, 4C and 4D are simplified circuit diagrams representing operations of the address electrode driver shown in FIG. 2.

FIG. 5 is a waveform diagram representing timings of the power recovery switch of FIG. 2 according to an exemplary embodiment of the present invention.

FIG. 6A is a diagram representing a dot ON/OFF pattern, and FIG. 6B is a diagram representing a panel capacitance when a video signal of the dot ON/OFF pattern is input.

FIG. 7A is a diagram representing a full white pattern, and FIG. 7B is a diagram representing a panel capacitance when a video signal of the full white pattern is input.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, unless explicitly described to the contrary, the word “comprise”, and variations such as “comprises” and “comprising”, will be understood to imply the inclusion of stated elements but not the exclusion of any other elements.

In addition, when it is described that an element is “coupled” to another element, the element may be “directly coupled” to the other element or “electrically coupled” to the other element through a third element.

A plasma display device according to an exemplary embodiment of the present invention and a driving method thereof will be described.

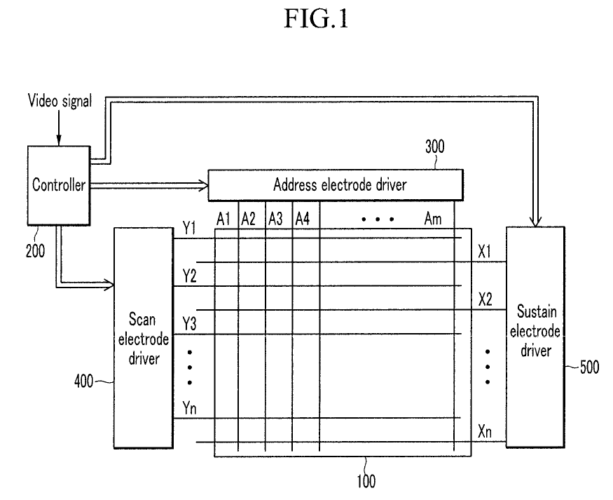

FIG. 1 is a block diagram of the plasma display device according to the exemplary embodiment of the present invention.

As shown in FIG. 1, the plasma display according to an exemplary embodiment of the present invention includes a plasma display panel (PDP) 100, a controller 200, an address electrode driver 300, a scan electrode driver 400, and a sustain electrode driver 500.

The PDP 100 includes a plurality of address electrodes (hereinafter referred to as “A electrodes”) A1 to Am extending in a column direction, and a plurality of sustain and scan electrodes (hereinafter referred to as “X electrodes” and “Y electrodes” respectively) X1 to Xn and Y1 to Yn extending in a row direction in pairs. In general, the X electrodes X1 to Xn are formed corresponding to the Y electrodes Y1 to Yn, respectively. The X electrodes and Y electrodes perform a display operation for displaying an image in the sustain period. The Y electrodes Y1 to Yn and the X electrodes X1 to Xn are disposed to cross the A electrodes A1 to Am. Discharge spaces at crossing regions of the A electrodes A1 to Am and the X and Y electrodes X1 to Xn and Y1 to Yn form cells 110. It is to be noted that the above construction of the PDP is only an example, and panels having different structures, to which a driving waveform to be described later can be applied, may be applied to embodiments of the present invention.

The controller 200 receives an external video signal, and outputs an A electrode driving control signal, an X electrode driving control signal, and a Y electrode driving control signal. In addition, the controller 200 divides one frame into a plurality of subfields, and gray levels are expressed by a combination of weight values of the subfields.

When receiving the A electrode driving control signal from the controller 200, the address electrode driver 300 selectively applies to the plurality of A electrodes A1 to Am address pulses for selecting cells to be turned on and cells not to be turned on during the address period.

When receiving the Y electrode driving control signal from the controller 200, the scan electrode driver 400 applies a driving voltage to the Y electrodes Y1 to Yn. Particularly, the scan electrode driver 400 selectively applies a scan pulse to the plurality of scan electrodes Y1 to Yn during the address period. For example, the scan electrode driver 400 may sequentially apply a scan pulse to the plurality of Y electrodes Y1 to Yn in the arrangement order of the plurality of Y electrodes in a column direction.

When receiving the X electrode driving control signal from the controller 200, the sustain electrode driver 500 applies a driving voltage to the X electrodes.

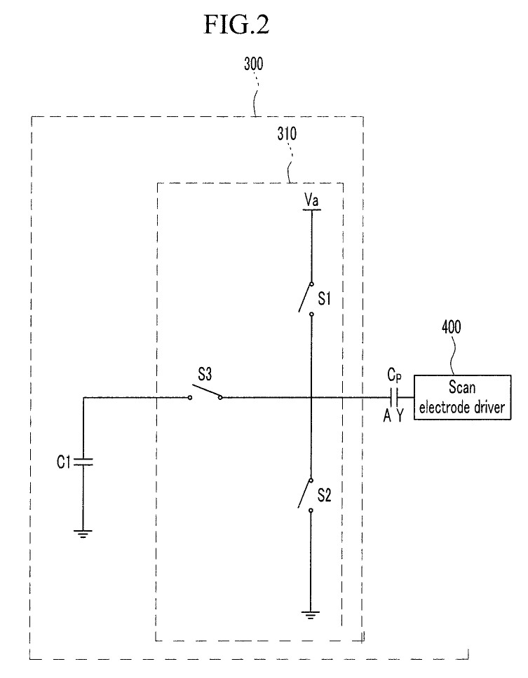

The address electrode driver 300 will be described with reference to FIG. 2.

FIG. 2 is a simplified circuit diagram of the address electrode driver 300 according to one exemplary embodiment of the present invention.

As shown in FIG. 2, the address electrode driver 300 according to one exemplary embodiment of the present invention includes at least one power recovery capacitor C1, and a plurality of address driving circuits 310 respectively coupled to the A electrodes A1 to Am shown in FIG. 2. In FIG. 2, for better understanding and ease of description, only an address driving circuit coupled to one A electrode A is illustrated, and a capacitive component formed by the A electrode A and the Y electrode Y is shown by a panel capacitor Cp. Among the plurality of address driving circuits 310, a number (e.g., a predetermined number) of address driving circuits 310 may be integrated into an integrated circuit (IC). The integrated circuit may be mounted on a packaging connection member (“package”), such as a tape carrier package (TCP), for example, in a chip. The packaging connection member may be bonded to the plasma display panel 100 and a printed circuit board (not shown) of the address electrode driver 300. In this case, the power recovery capacitor C1 may be mounted on the printed circuit board and be coupled to the integrated circuit on the packaging connection member.

Also, at least one power recovery capacitor C1 may be commonly coupled to the plurality of address driving circuits 310 coupled to the plurality of address electrodes (the reference symbols A1 to Am in FIG. 1). Alternatively, separate power recovery capacitors C1 may be coupled to a number of address driving circuits (for example, an integrated circuit including a predetermined number of address driving circuits) for every address driving circuit. Hence, one or more address driving circuits may be coupled to the same power recovery capacitor C1. Here, it is assumed that the size of the power recovery capacitor C1 is larger than the panel capacitor Cp and thus variation in the voltage of the power recovery capacitor C1 due to a current charged to or discharged from the panel capacitor Cp when a switch S3 is turned on is relatively small. Further, it is assumed that the power recovery capacitor C1 supplies a voltage having a level between an address voltage Va and a voltage of 0V. By way of example, in one embodiment, the level of the voltage supplied by the power recovery capacitor C1 is about half that of the address voltage.

The address driving circuit 310 includes a driving switch S1, a grounding switch S2, and a power recovery switch S3. In one embodiment, the controller 200 (see FIG. 1) provides control signals for turning on or off the switches S1, S2 and S3. The driving switch S1 has a first terminal coupled to a power source Va for supplying a high level voltage of the address pulse (i.e., the address voltage Va) and a second terminal coupled to the A electrode. The grounding switch S2 has a first terminal coupled to a power source for supplying a low level voltage of the address pulse (i.e., a non-address voltage, 0V in FIG. 2) and a second terminal coupled to the A electrode. The power recovery switch S3 has a first terminal coupled to the power recovery capacitor C1 and a second terminal coupled to the A electrode. In FIG. 2, a field effect transistor may be used as each of the switches S1, S2, and S3, or different switches having the same or similar function may be used as the switches S1, S2, and/or S3. Also, when transistors with a body diode are used as the switches S1, S2, and S3, the switch S3 may be formed of a back-to-back transistor to block a path through which the power recovery capacitor C1 is charged or discharged due to the body diodes.

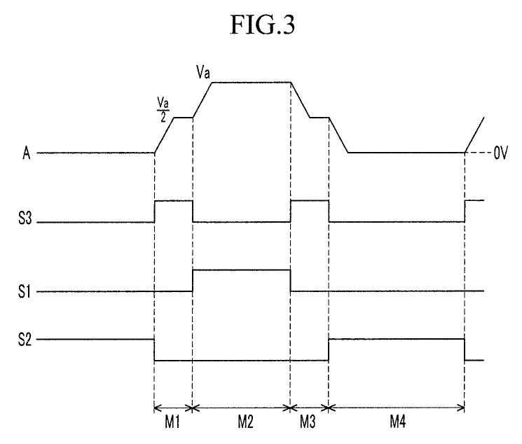

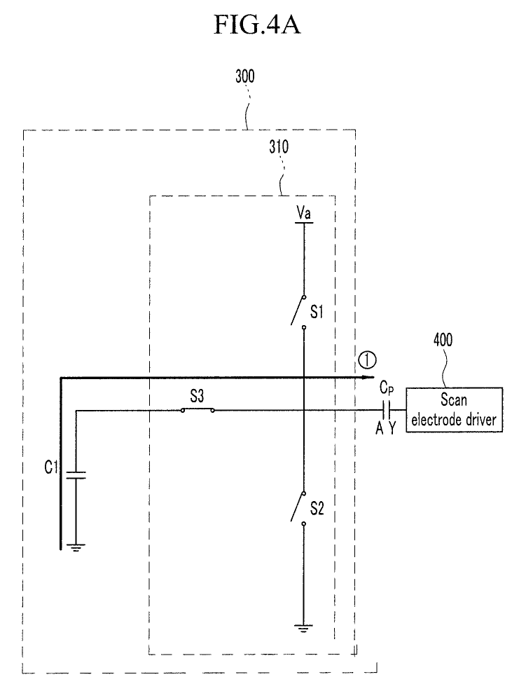

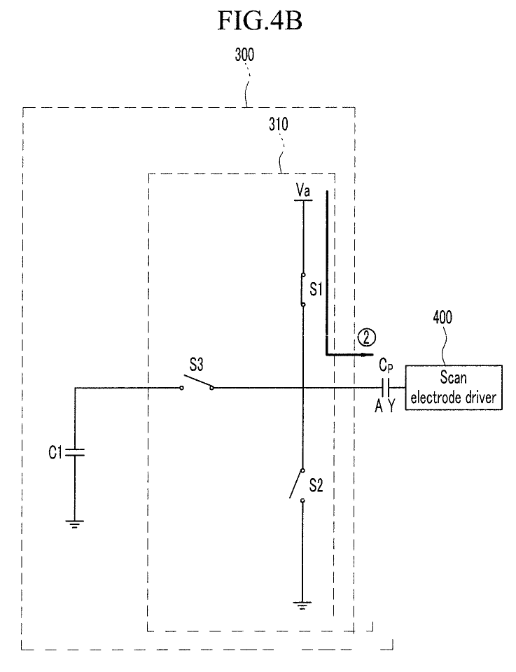

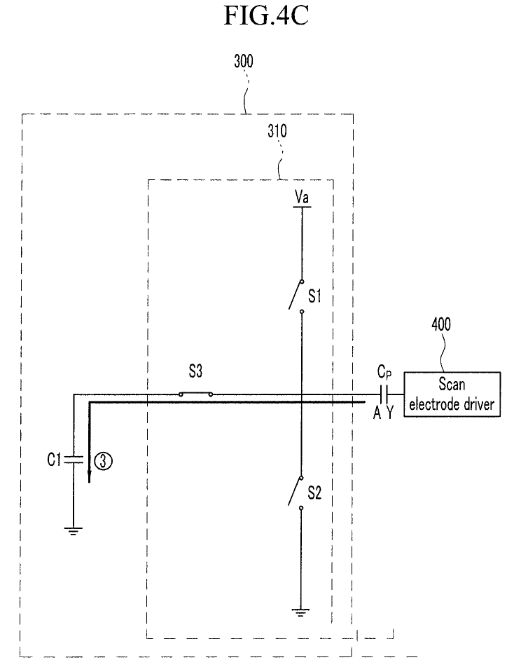

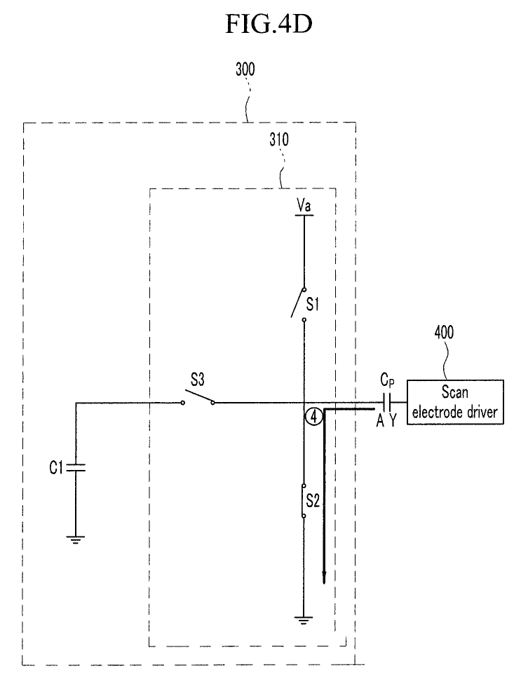

An operation of the address electrode driver 300 shown in FIG. 2 will now be described with reference to FIG. 3 and FIG. 4A to FIG. 4D.

FIG. 3 is a waveform diagram representing signal timing of the address electrode driver 300 shown in FIG. 2, and FIG. 4A to FIG. 4D are simplified circuit diagrams representing operations of the address electrode driver 300 shown in FIG. 2. First, it is assumed that the grounding switch S2 is turned on and the ground voltage 0V is applied to the A electrode A before a mode 1 M1 is started.

As shown in FIG. 3 and FIG. 4A, in the mode 1 M1, the grounding switch S2 is turned off (i.e., open) and the power recovery switch S3 is turned on (i.e., closed). Thereby, as shown in FIG. 4A, a voltage charged in the power recovery capacitor C1 is directly charged to the panel capacitor Cp through a current path (1) of the power recovery capacitor C1, the power recovery switch S3, and the panel capacitor Cp. Accordingly, a voltage at the A electrode A increases from the 0V voltage to a voltage that is close to a desired voltage (e.g., a predetermined voltage). In this case, the voltage at the A electrode A is determined by a turn-on time of the power recovery switch S3. A Va/2 voltage is charged in the power recovery capacitor C1, and the voltage at the A electrode may increase to the Va/2 voltage provided that the capacity of the power recovery capacitor C1 is relatively large in comparison to the capacity of the panel capacitor Cp.

Then, when the voltage of the power recovery capacitor C1 is directly charged in the panel capacitor Cp, a charging time may be reduced to be shorter than a time for charging the panel capacitor Cp by using resonance of an external inductor and the panel capacitor Cp.

As shown in FIG. 3 and FIG. 4B, in a mode 2 M2, the power recovery switch S2 is turned off (i.e., open) and the driving switch S1 is turned on (i.e., closed). Thereby, as shown in FIG. 4B, the Va voltage is applied to the A electrode of the panel capacitor Cp through a path (2) of a power source Va, the driving switch S1, and the panel capacitor Cp.

As shown in FIG. 3 and FIG. 4C, in a mode 3 M3, the driving switch S2 is turned off (i.e., open) and the power recovery switch S3 is turned on (i.e., closed). Thereby, as shown in FIG. 4C, the voltage charged in the panel capacitor Cp is recovered to the power recovery capacitor C1 through a path (3) of the panel capacitor Cp, the power recovery switch S3, and the power recovery capacitor C1. Then, the voltage at the A electrode A decreases from a Va voltage to be close to a desired voltage (e.g., a predetermined voltage). Provided that the capacity of the power recovery capacitor C1 is relatively large in comparison to the capacity of the panel capacitor Cp, the voltage at the A electrode A may be reduced to the Va/2 voltage.

Subsequently, as shown in FIG. 3 and FIG. 4D, in a mode 4 M4, the power recovery switch S3 is turned off (i.e., open) and the grounding switch S2 is turned on (i.e., closed). Thereby, as shown in FIG. 4D, the 0V voltage is applied to the A electrode A of the panel capacitor Cp through a path (4) of the ground, the grounding switch S2, and the panel capacitor Cp.

In an exemplary embodiment according to the present invention, the A electrode A may be floated for a period (e.g., a predetermined period) between the mode 1 M1 and the mode 2 M2 and between the mode 3 M3 and the mode 4 M4. This is because, without a floating period, the driving switch S1 and the power recovery switch S3 may be concurrently turned on because of a reverse recovery time of the power recovery switch S3 in the mode 2 M2, thereby causing an operational problem for the address electrode driver 300. Similarly, without a floating period, the grounding switch S2 and the power recovery switch S3 may be concurrently turned on because of a reverse recovery time of the power recovery switch S3 in the mode 4 M4. Also in this case, since the voltage charged in the power recovery capacitor C1 is discharged through the grounding switch S2, the address electrode driver 300 may have an operational problem. Therefore, according to one embodiment of the present invention, by floating the A electrode for a time (e.g., a predetermined time) between the mode 1 M1 and the mode 2 M2 and between the mode 3 M3 and the mode 4 M4, the driving switch S1 and the power recovery switch S3 may be prevented from being concurrently turned on and the grounding switch S2 and the power recovery switch S3 may be prevented from being concurrently turned on.

The modes 1 to 4 (M1 to M4) operate when data applied to the A electrode A varies. For example, the modes 1 to 4 (M1 to M4) operate when the 0V voltage is applied to the A electrode A while the scan pulse is applied to a first Y electrode (Y1 in FIG. 1), the Va voltage is applied to the A electrode A while the scan pulse is applied to a second Y electrode (Y2 in FIG. 1), and the 0V voltage is applied to the A electrode A while the scan pulse is applied to a third Y electrode (Y3 in FIG. 1). However, the Va voltage may be continuously applied to the A electrode A without the mode 3 M3 (i.e., without reducing the voltage at the A electrode A) when the Va voltage is applied to the A electrode A while the scan pulses are applied, respectively, to the second and third scan electrodes (Y2 and Y3 in FIG. 1). Similarly, the 0V voltage may be applied to the A electrode A without the mode 1 M1 (i.e., without increasing the voltage at the A electrode A) when the 0V voltage is applied to the A electrode A while the scan pulses are applied, respectively, to the second and third scan electrodes (Y2 and Y3 in FIG. 1).

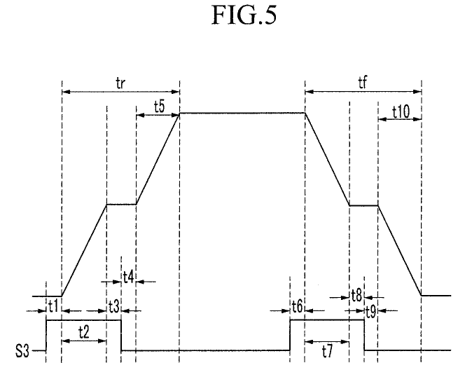

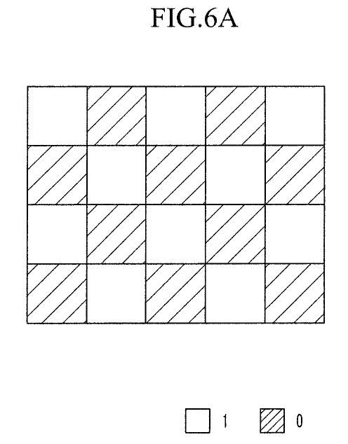

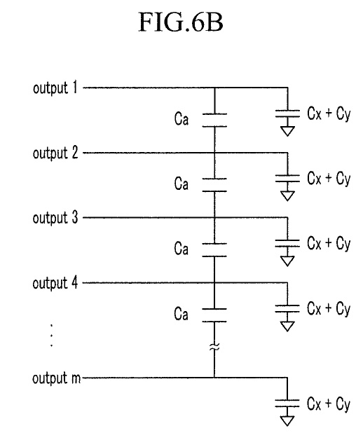

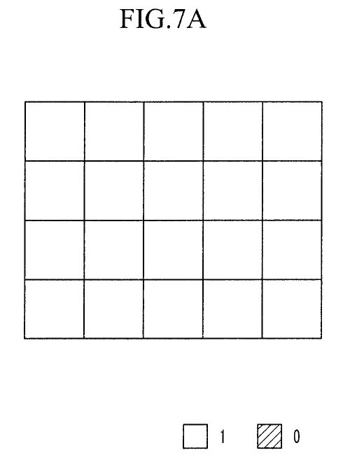

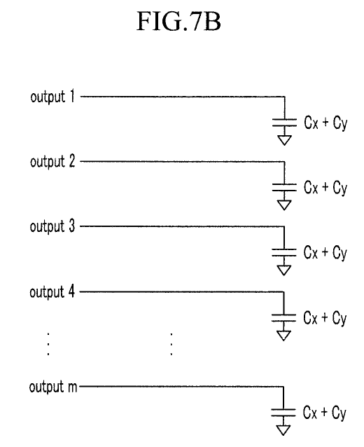

In addition, when a turn-on period (M1 in FIG. 3) of the power recovery switch S3 is relatively short when the voltage at the A electrode A increases, the voltage at the A electrode A may increase to a voltage that is lower than the Va/2 voltage. Similarly, when the turn-on period (M3 in FIG. 3) of the power recovery switch S3 is relatively short when the voltage at the A electrode A decreases, the voltage at the A electrode may decrease to a voltage that is higher than the Va/2 voltage. In other words, when a period (M1 and M3 in FIG. 3) for varying the voltage at the A electrode is relatively short, an address discharge may be stably generated since a period (M2 in FIG. 3) for applying the Va voltage to the A electrode A is increased, however, power recovery efficiency may be reduced since charge movement to the power recovery capacitor C1 is less. In addition, the power recovery efficiency may be increased when the turn-on period (M1 and M3 in FIG. 3) of the power recovery switch S3 is relatively long when the voltage at the A electrode A increases, but the address discharge may not be properly generated since the period (M2 in FIG. 3) for applying the Va voltage to the A electrode A is reduced. A range of the turn-on period of the power recovery switch S3 to increase the power recovery efficiency while reducing or minimizing a failure rate of the address discharge will now be described with reference to FIG. 5, FIG. 6A, FIG. 6B, FIG. 7A, and FIG. 7B.

FIG. 5 is a waveform diagram representing timings of the power recovery switch S3 according to an exemplary embodiment of the present invention, FIG. 6A is a diagram representing a dot ON/OFF pattern, and FIG. 6B is a diagram representing a panel capacitance when a video signal of the dot ON/OFF pattern is input. FIG. 7A is a diagram representing a full white pattern, and FIG. 7B is a diagram representing a panel capacitance when a video signal of the full white pattern is input.

As shown in FIG. 5, a period Tᵣ during which the voltage at the A electrode A varies from the 0V voltage to the Va voltage is defined by Equation 1, and a period T_{erc(r)} during which the power recovery switch S3 is turned on is defined by Equation 2.

Tr=t2+t3+t4+t5 (Equation 1)

T_{erc}=t₁+t₂+t₃ (Equation 2)

Here, t1 denotes an idle period, t2 denotes a period for charging the panel capacitor Cp by using charges of the capacitor C1, and t3 is generally set to be 0. t4 is a high impedance state in which the switches S1, S2, and S3 are turned off and floated.

When the video signal of the dot ON/OFF pattern shown in FIG. 6A (i.e., a pattern in which the address data are continuously changed from 1 to 0 and 0 to 1) is input, panel capacitances Cy and Cx between the A electrode and the Y and X electrodes are formed, and a panel capacitance Ca is formed between neighboring A electrodes. Accordingly, the panel capacitances Cp coupled to outputs output 1 to output m of the respective address driving circuits 310 are formed as shown in FIG. 6B, and the panel capacitance coupled to an output of one address driving circuit 310 is a value of (Cx+Cy+Ca+Ca).

In addition, when the video signal of the full white pattern shown in FIG. 7A (i.e., a pattern in which the address data does not vary) is input, the panel capacitances Ca between neighboring A electrodes are not formed since the same potential is provided between the neighboring A electrodes, while the panel capacitances Cy and Cx between the A electrodes and the Y and X electrodes are formed. Accordingly, the panel capacitance Cp coupled to the outputs output 1 to output m of the respective address driving circuits 310 is formed as shown in FIG. 7B, and the panel capacitance Cp coupled to the output of one address driving circuit 310 is a value of (Cx+Cy).

In general, the address pulse has a predetermined width (e.g., 1 μs to 3.0 μs) regardless of the power recovery operation, and the address pulse has a width of 1 μs to 2.0 μs in high speed addressing. In this case, a period for maintaining the Va voltage is required to be greater than an address discharge delay to perform a stable address discharge. The address discharge delay includes a statistical delay T(s) and a discharge forming delay T(f). In addition, the address discharge delay is approximately within a range of 300 ns to 600 ns at room temperature, and it is approximately within a range of 400 ns to 700 ns at a low temperature (e.g., temperature lower than a room temperature). Accordingly, the period for maintaining the Va voltage in one embodiment should be greater than 700 ns.

In addition, since Iₒᵤₜ in one embodiment is a value of 15 mA to 18 mA, provided that that the value of (Cx+Cy) is 30 pF and a value of Ca is 15 pF, the periods T_{erc(r)} for turning on the power recovery switch S3 in the dot ON/OF pattern and the full white pattern are given as Table 1. In this case, since power P is proportional to a value of (voltage V)², power consumption is reduced by 31% of using a 60V voltage when using a 50V voltage, and the power consumption is reduced by 56% of using the 60V voltage when using a 40V voltage. Accordingly, when the 50V or 40V voltage is used as the Va voltage, the power recovery circuit may not be needed. Accordingly, it is assumed that the Va voltage is the 60V voltage. In addition, it is assumed that t1 and t6 are respectively 12 ns, and t3 and t8 are respectively 0 ns. In this case, t1 and t6 are minimum design values for normally driving the address driving circuit 310, the address driving circuit 310 may not be normally driven when t1 and t6 are below 12 ns, and a time for driving the plasma display may be wasted when t1 and t6 are greater than 12 ns. However, t1 and t6 may vary according to a design.

TABLE 1

| | Dot ON/OFF pattern | Full white pattern |
|---|---|---|
| Iₒᵤₜ = | T_{erc(r)} = | T_{erc(r)} = |
| 15 mA | 12 ns + 120 ns + 0 ns = 132 ns | 12 ns + 60 ns + 0 ns = 72 ns |
| Iₒᵤₜ = | T_{erc(r)} = | T_{erc(r)} = |
| 18 mA | 12 ns + 100 ns + 0 ns = 112 ns | 12 ns + 50 ns + 0 ns = 62 ns |

As shown in Table 1, according to the exemplary embodiment of the present invention, the period T_{erc(r)} for turning on the power recovery switch S3 is set to be greater than 62 ns and less than 132 ns. In this case, power consumption of the address driving circuit 310 increases since charge movement from the power recovery capacitor C1 to the panel capacitor Cp is less when the period T_{erc(r)} for turning on the power recovery switch S3 is shorter than 62 ns, and the period for maintaining the Va voltage is reduced when the period T_{erc(r)} for turning on the power recovery switch S3 is increased to be longer than 132 ns. Accordingly, the period for maintaining the Va voltage may be less than 700 ns. Thereby, the address discharge may not be generated. The period T_{erc(r)} for turning on the power recovery switch S3 may be greater than about 62 ns and less than about 132 ns.

As shown in FIG. 5, a period T_{f} during which the voltage at the A electrode A varies from the Va voltage to the 0V voltage is defined by Equation 5, and a period T_{erc(f)} for turning on the power recovery switch S3 may be defined by Equation 6.

T_{f}=t7+t8+t9+t10 (Equation 5)

T_{erc(f)}=t6+t7+t8 (Equation 6)

Here, t6 is an idle period, t7 is a period for charging the panel capacitor Cp by using charges of the power recovery capacitor C1, and t8 is generally set to be 0. t9 is a high impedance state, in which the switches S1, S2, and S3 are turned off and floated.

That is, the period T_{erc(f)} for turning on the power recovery switch S3 within the period T_{f} during which the voltage at the A electrode varies from the Va voltage to the 0V voltage is the same as the period T_{erc(r)} for turning on the power recovery switch S3 within the period Tᵣ during which the voltage at the A electrode A varies from the 0V voltage to the Va voltage.

In the exemplary embodiment of the present invention, while the driving circuit shown in FIG. 2 is applied to the address electrode driver 300, the driving circuit shown in FIG. 2 may be applied to the scan electrode driver 400 and/or the sustain electrode driver 500 for driving the Y electrodes and/or the X electrodes.

According to the exemplary embodiment of the present invention, the power recovery efficiency may be improved while the failure rate of the address discharge is reduced or minimized.

While the present invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims and their equivalents.

What is claimed is:

1. A plasma display comprising:
a plasma display panel comprising an electrode;
a driver comprising a power recovery capacitor and a driving circuit, the driving circuit including a switch for controlling a current path between the power recovery capacitor and the electrode; and
a controller configured to turn on the switch during a first period within a period for varying a voltage at the electrode from a first voltage to a second voltage and during a second period within a period for varying the voltage at the electrode from the second voltage to the first voltage,
wherein each of the first and second periods is greater than about 62 ns.

2. The plasma display of claim 1, wherein the driving circuit comprises an integrated circuit.

3. The plasma display of claim 1, further comprising a package for coupling the electrode to the power recovery capacitor, wherein the driving circuit is mounted on the package.

4. The plasma display of claim 3, wherein the package comprises a tape carrier package.

5. The plasma display of claim 1, wherein each of the first and second periods is less than about 132 ns.

6. The plasma display of claim 5, wherein the driver comprises:
a second switch coupled between a first power source for supplying the first voltage and the electrode; and
a third switch coupled between a second power source for supplying the second voltage and the electrode.

7. A method for driving a plasma display comprising a plasma display panel, an address driver, and a power recovery capacitor, the plasma display panel comprising an address electrode, and the address driver comprising a switch coupled to the address electrode for controlling a current path between the address electrode and the power recovery capacitor, the method comprising:
varying a voltage at the address electrode from a first voltage to a second voltage;
turning on the switch during a period for varying the voltage at the address electrode from the first voltage to the second voltage;
varying the voltage at the address electrode from the second voltage to the first voltage; and
turning on the switch during a period for varying the voltage at the address electrode from the second voltage to the first voltage,
wherein a time for turning on the switch is greater than about 62 ns.

8. The method of claim 7, wherein the address driver comprises an integrated circuit.

9. The method of claim 8, further comprising:
floating the address electrode before the second voltage is applied to the address electrode after the voltage at the address electrode is changed to the second voltage; and
floating the address electrode before the first voltage is applied to the address electrode after the voltage at the address electrode is changed to the first voltage.

10. The method of claim 7, wherein the plasma display further comprises a package for coupling the address electrode to the power recovery capacitor, wherein the address driving circuit is mounted on the package.

11. The method of claim 7, wherein the time for turning on the switch is less than about 132 ns.

12. A plasma display comprising:
a plasma display panel comprising a plurality of address electrodes, a plurality of sustain electrodes crossing the plurality of address electrodes, and a plurality of discharge cells located at crossing regions of the address electrodes and the sustain electrodes;
a sustain driver for applying sustain signals on the sustain electrodes;
an address driver comprising at least one power recovery capacitor and a plurality of driving circuits coupled to the at least one power recovery capacitor, each of the driving circuits including a switch for selectively electrically coupling the at least one power recovery capacitor to a corresponding one of the plurality of address electrodes; and
a controller for providing control signals to the sustain driver and the address driver, the controller configured to provide a turn-on signal to the switch for at least about 62 ns while the voltage at the corresponding one of the plurality of address electrodes increases from a first voltage to a second voltage, and while the voltage at the corresponding one of the plurality of address electrodes decreases from the second voltage to the first voltage.

13. The plasma display of claim 12, wherein the controller is configured to provide the turn-on signal to the switch for less than about 1 32ns while the voltage at the corresponding one of the plurality of address electrodes increases from the first voltage to the second voltage, and while the voltage at the corresponding one of the plurality of address electrodes decreases from the second voltage to the first voltage.

14. The plasma display of claim 13, wherein each of the driving circuits further comprises:
a second switch coupled between a first power source for supplying the first voltage and the corresponding one of the address electrodes; and
a third switch coupled between a second power source for supplying the second voltage and the corresponding one of the address electrodes.

15. The plasma display of claim 12, wherein the first voltage is a ground voltage and the second voltage is an address voltage.
